(19) United States
(12) Patent Application Publication
(10) Pub. No.: US 2019/0311023 A1
(43) Pub. Date: Oct. 10, 2019

(54) AUTOMATED REFERENCE LIST BUILDER

(71) Applicant: Li-Cor, Inc., Lincoln, NE (US)

(72) Inventors: Frank Griessbaum, Lincoln, NE (US); Gerardo Fratini, Lincoln, NE (US); George Burba, Lincoln, NE (US)

(21) Appl. No.: 16/372,808

(22) Filed: Apr. 2, 2019

Related U.S. Application Data
(60) Provisional application No. 62/654,087, filed on Apr. 6, 2018.

(51) Int. Cl. G06F 17/24; G06F 17/22; G06F 17/21; G06F 16/38

(52) U.S. Cl. CPC G06F 17/24; G06F 16/382; G06F 17/218; G06F 17/2205

(57) ABSTRACT

A device for managing a reference list. The device includes one or more processors, which alone or in combination are configured to facilitate performing: (a) running one or more applications; (b) selecting the reference list; (c) monitoring activities in the one or more applications to identify citable processes; (d) receiving citable information from the one or more applications based on the citable processes; (e) determining a type of citable information received; and (f) modifying the reference list based on the type of citable information received.

### CROSS REFERENCES

The present Application for Patent claims priority to U.S. Provisional Patent Application No. 62/654,087 by Griessbaum et al., entitled “Automated Reference List Builder,” filed Apr. 6, 2018, which is incorporated in its entirety herein by reference.

### BACKGROUND

References and citations to sources are found within printed or electronic publications, codes, presentations, etc., to point readers to specific places where certain information is obtained. The references can be provided in the publication as a list or a table with internal citations provided within the publication. References and citations heavily depend upon user intervention while writing the publication or report. Reference management software in the art are being used as a way to insert references in the publication during the drafting stage. Reference management software are also used to link citations within the publication to the references at the end of the publication. Reference management software also include one or more citation formats for the insertion of the citations and references in the publication. In the current art, reference management software includes a list of references or a reference database, and as a user is drafting the publication, the user can select a subset of those references for use in the publication.

### SUMMARY

An embodiment of the disclosure provides a device for managing a reference list. The device includes one or more processors, which alone or in combination are configured to facilitate performing: (a) running one or more applications; (b) selecting a reference list, table, or sequence; (c) monitoring activities in the one or more applications to identify citable processes; (d) receiving citable information from the one or more applications based on the citable processes; (e) determining a type of citable information received; and (f) modifying the reference list based on the type of citable information received.

An embodiment of the disclosure provides a method for managing a reference list performed by a computing device. The method includes: (a) running one or more applications; (b) selecting a reference list, table, or sequence; (c) monitoring activities in the one or more applications to identify citable processes; (d) receiving citable information from the one or more applications based on the citable processes; (e) determining a type of citable information received; and (f) modifying the reference list based on the type of citable information received.

### BRIEF DESCRIPTION OF THE SEVERAL VIEWS OF THE DRAWINGS

Embodiments of the present invention will be described in greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates a computing device for maintaining an automated reference list according to an embodiment of the disclosure; and

FIG. 2 is a flowchart for managing a reference list according to an embodiment of the disclosure.

### DETAILED DESCRIPTION

Reference management software in the current art provide convenience of including references in a document, but relies heavily on a user's memory to properly select the references to be used in the document. In a typical scientific process that includes documenting steps within the process, data analysis tends to be done at the end of an experimental method. Documentation while performing the experimental method is thus delegated to the experimenter or user, and the accuracy of this documentation is relied upon in order to write up a paper or manuscript analyzing the experimental method. A scientific paper is usually properly sourced, as such, the documentation of the steps involved should provide a hint of which references should be included in the paper. Reference management software in the current art are unable to be automatically linked to the documentation of steps and require the experimenter or user to manually make those connections.

In the scientific process, an experimenter can take many steps while performing an experimental method, and these steps when taken together can become very complex. Documentation of steps as performed today is deficient because reproducing results in some scientific disciplines is a problem. In some cases, documentation of the software used during analysis is not done properly or at all. In most cases, a user does not remember minute details that can be pertinent for others to recreate the experiment and reproduce the results. In some cases, a user imports and exports data between multiple applications that the processing steps can become muddled in the user's mind. As such, automating the documentation process will capture minute details, and providing a reference list borne out of the documentation process will improve chances of reproducing results of the user by the scientific community.

Preparation of a scientific paper or manuscript is provided as an example. It is understood that an experimenter can prepare or develop reports, presentations, teaching material, code, algorithms, etc., as a result of an experimental method. Thus, documentation of the steps performed during the experimental method can be used to create (a) a processing workflow such as code, etc.; and (b) an analytical workflow such as algorithms, code, etc. Documentation of the steps performed can be used to process and analyze information. Documentation of the steps performed can be used to write up a paper, report, resultant code or algorithm, or make a presentation or teaching material. Each of these activities can benefit from documentation of steps and/or generation of a reference list, a reference table, a reference sequence, etc. Thus, preparation of a manuscript or scientific paper is provided as an example and does not limit the scope of the disclosure.

Embodiments of the disclosure provide a method for tracking steps performed during an experimental process. Data import is tracked to document where the data came from. Data manipulations and transformations are tracked to reference algorithms used in the transformations. Steps performed to generate graphs, tables, or other visual displays are tracked to provide a reference list. As such, the embodiments encourage traceable, repeatable and reproducible results, exhibit ease of use in reference management, avoid mistakes in documentation generally associated with reliance on user memory, and catalogs what data was used in an experimental process, what algorithms were used on the data, and what order the steps were performed. In tracking experimental steps, embodiments of the disclosure provide several advantages in computer technology. The embodiments allow tracking of processes performed by disparate software working on similar data and provides a reference list, reference table, or reference sequence that encompasses activities performed on the disparate software. The reference list can be part of an automated generation of documentation for troubleshooting software errors since datasets imported by the software and activities performed by the software are provided in-order.

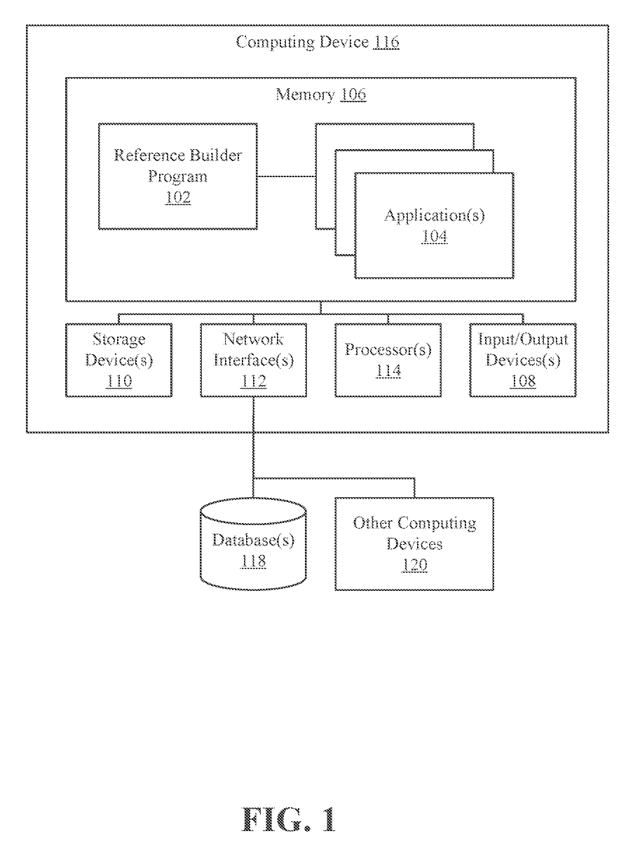

FIG. 1 illustrates a computing device 116 for maintaining an automated reference list according to an embodiment of the disclosure. Examples of the computing device 116 include a mobile device, laptop computer, a desktop computer, a workstation, a server, etc. The computing device 116 includes a memory 106, one or more storage devices 110, one or more network interfaces 112, one or more processors 114, and one or more input/output (I/O) devices 108. Each component included in the computing device 116 is interconnected physically, communicatively, and/or operatively for inter-component communications in order to realize functionality ascribed to the computing device 116. The computing device 116 can interface with one or more databases 118 and/or other computing devices 120 via the network interface 112. With aid of the processor 114, the computing device 116 can load stored instructions to memory 106 to run a reference builder program 102 which monitors one or more applications 104 for maintaining the automated reference list.

Processor 114 is configured to implement functions and/or process instructions for execution within the computing device 116. For example, processor 114 executes instructions stored in memory 106 or instructions loaded from the storage device 110. Memory 106, which may be a non-transient, computer-readable storage medium, is configured to store information within the computing device 116 during operation, for example, during executing of application 104 and reference builder program 102. Memory 106 can include a temporary memory that does not retain information stored in absence of electric power. Examples of temporary memory include volatile memories such as random access memories (RAM), dynamic random access memories (DRAM), static random access memories (SRAM), etc. Memory 102 also maintains program instructions for execution by the processor 114 and serves as a conduit for other storage devices (internal or external) coupled to the computing device 116 to gain access to processor 114. In an example, memory can serve as a conduit for database 118.

Storage device 110 includes one or more non-transient or non-transitory computer-readable storage media. Storage device 110 is provided to store larger amounts of information than memory 106, and in some instances, configured for long-term storage of information. The storage device 110 can include non-volatile storage elements, e.g., flash memories, magnetic hard discs, optical discs, solid state drives, forms of electrically programmable memories (EPROM) or electrically erasable and programmable (EEPROM) memories, etc.

Network interfaces 112 are used to communicate with external devices, computers, and/or servers. Network interfaces 112 can include network interface cards, such as Ethernet cards, optical transceivers, radio frequency transceivers, or any other type of device that can send and/or receive information. Network interfaces 112 can include radios compatible with several Wi-Fi standards, 3G, 4G, Long-Term Evolution (LTE), Bluetooth®, etc.

The computing device 116 may also be equipped with one or more I/O devices 108. I/O device 108 is configured to receive input and/or provide output to a user. Output can be provided to the user via tactile, audio, and/or video information. I/O device can include displays (liquid crystal display (LCD) display, LCD/light emitting diode (LED) display, organic LED display, quantum dot display, etc.), sound cards, video graphics adapter cards, speakers, magnetics, or any other type of device that may generate an output intelligible to a user of the computing device 116. Input can be received from the user or the environment where the computing device 116 is located. I/O device 108 that receive inputs can include presence-sensitive screens or touch-sensitive screens, mice, keyboards, cameras, microphones, etc.

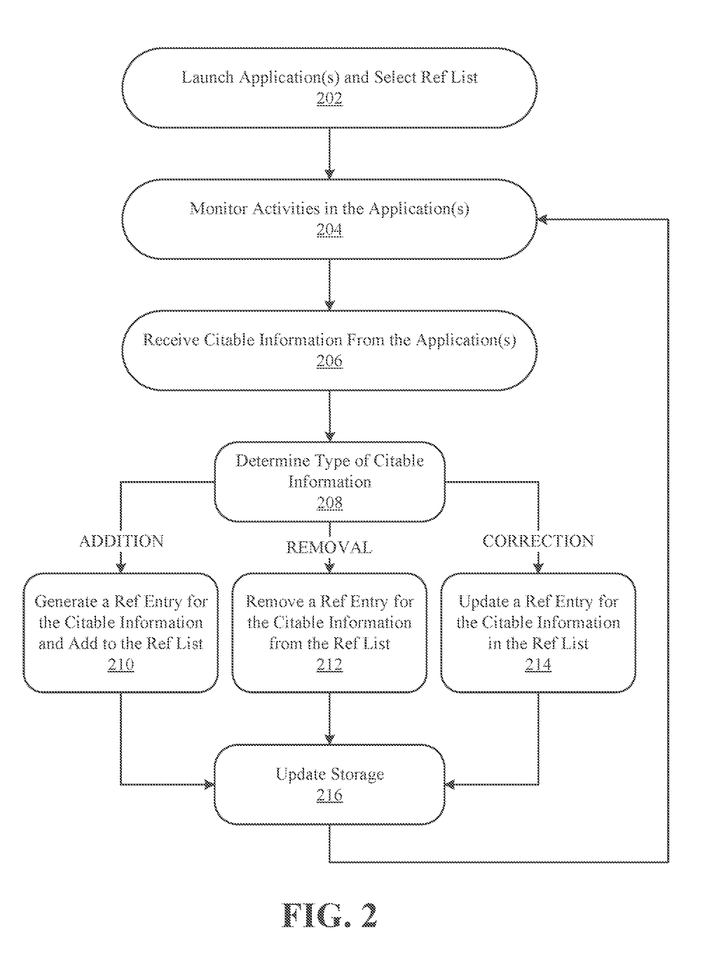

FIG. 2 is a flowchart for managing a reference list according to an embodiment of the disclosure. At 202, the computing device 116 launches one or more applications 104 and selects a reference list. The term reference list as used herein is not limited to a list of literature references only, and may include any list of information one can refer to in a later process. The reference builder program 102 running on the computing device 116 notes the applications 104 running on the computing device 116 and selects and appropriate reference list based on the applications 104. The reference list selected can be a newly created reference list with no reference entries. The reference list selected can be an existing reference list that is retrieved from storage, e.g., retrieved from storage device 110 or from database 118. The applications 104 can be data analysis software, data visualization software, data modeling software, data processing software suites, etc.

At 204, the reference builder program 102 on the computing device 116 monitors activities in the one or more applications 104 to identify citable processes, e.g., whether the applications 104 are running citable algorithms or using other citable information. The reference builder program 102 on the computing device 116 tracks active applications and active windows to determine which applications 104 that a user is currently working in. The reference builder program 102 can determine active windows from tracking information obtained from the operating system running the applications 104. In an embodiment, citable processes are identified in active applications. As used herein, “citable” is not limited to “scientifically citable” or literature citable, and may include any information contained in a reference list.

In an embodiment, the reference builder program 102 monitors activities in the applications 104 to determine whether the applications 104 are running a citable algorithm, code, sequence, etc. For example, a data processing software suite can include multiple code snippets and toolboxes for implementing various algorithms for performing data manipulation. Description of the toolboxes or comments in the code snippets can identify their sources or authors. The reference builder program 102 can probe the toolbox or code being executed by the application 104 to determine whether the toolbox or code is citable. A citable toolbox or code or algorithm implemented by the toolbox or code is one that can be linked to a reference source. In an embodiment, the reference source can be included in the application running the toolbox. In another embodiment, the reference builder program 102 can obtain an identification of the algorithm and then perform a search of one or more databases using information in the identification of the algorithm to determine whether the algorithm is citable.

In an embodiment, the reference builder program 102 monitors activities in the applications 104 to determine whether the one or more applications is importing a citable dataset or other information. For example, a data processing software suite can use a digital object identifier (DOI) of a dataset to locate, download, and import the dataset. The reference builder program 102 can capture the DOI from the data processing software suite and determine that the DOI is being used for data import based on the contents of the DOI and location to which the DOI points to. Other information other than datasets can be imported using DOI, as such, the reference builder program 102 monitors whether the one or more applications imports information using DOIs.

In an embodiment, the reference builder program 102 monitors activities in the applications 104 to determine whether the one or more applications performed an undo or a revert operation. During data analysis or while perfecting an experimental procedure, mistakes can be made or procedures can be modified based on unpromising results. As such, the reference builder program 102 tracks the applications 104 to determine whether an undo operation is performed or whether a revert operation is performed. A revert operation involves loading a previous state of an application from storage while an undo operation involves returning to a most recent state of an application.

In an embodiment, the reference builder program 102 monitors activities in the applications 104 to determine whether the applications 104 performed a save operation. A save operation commits a certain state of an application to memory.

At 206, the reference builder program 102 on the computing device 116 receives citable information from the one or more applications based on the citable processes. In an embodiment, the reference builder program 102 receives citable information in the form of an algorithm signature from the applications 104. The algorithm signature may include name of the algorithm, a DOI identifying the algorithm, etc. In an embodiment, the reference builder program 102 receives citable information in the form of a dataset identification from the one or more applications. The dataset identification can include name of the dataset, owner of the dataset, a DOI identifying the dataset, etc. The reference builder program 102 can also receive citable information that includes software version(s) of the applications 104, software version(s) of added features or toolboxes of the applications 104, user identification or community identification of custom-made added features of the applications 104, and settings information of the applications 104 (e.g., settings, thresholds, and so on applied during data processing).

At 208, the reference builder program 102 on the computing device 116 determines a type of citable information received at step 206. The type of citable information received can indicate an addition, a removal, and/or a correction of an entry in the reference list selected at 202.

At 210, if the type of citable information indicates an addition of an entry, the reference builder program 102 modifies the reference list by generating a reference entry for the citable information and then adding the reference entry to the reference list. In an example, if the applications 104 are running a citable algorithm and the citable information is an algorithm signature, then a reference entry is created using the algorithm signature. The reference entry can have an order number associated with it to indicate the order in which the entry is added to the reference list. The reference entry can include the name of the algorithm and/or the version of the algorithm. The reference entry can include a bibliographic citation of the algorithm, e.g., authors, journal or conference title, abstract describing the bibliographic citation, publisher, DOI, universal resource locator (URL), number of pages, international standard book number (ISBN), year, etc. The reference entry can also include a short description of how the algorithm (or reference entry) is valid to the experimental procedure being tracked by the reference builder program 102. In an embodiment, the short description can be generated from a dictionary of verbs, DOIs, application, and order numbers in the reference list. For example, the reference builder program 102 can determine that an algorithm ALGO3 is applied to DATA5, so the short description for using the algorithm ALGO3 can be “applying ALGO3 to DOI:DATA5,” where DOI:DATA5 represents DOI of the DATA5 dataset.

In an embodiment, the applications 104 import or export a dataset DATA5 and the reference builder program 102 receives dataset identification from the applications 104. The reference builder program 102 creates the reference entry using the dataset identification. The short description included in the reference entry can be “importing DOI:DATA5 to APP1” or “exporting DOI:DATA5 to APP2” or “importing DOI:DATA5 to APP3 using CONF1,” where CONF1 includes settings and configurations for the import. Settings can include data truncation to a certain number of significant figures, rounding up or down, adding or stripping formatting, Boolean operations used to filter out a subset of the data being imported or exported, etc.

In generating reference entries, the reference builder program 102 can include software version(s) of the applications 104, software version(s) of added features or toolboxes of the applications 104 being used, user identification or community identification of custom-made added features of the applications 104 being used.

At 212, if the type of citable information indicates a removal, then the reference builder program 102 modifies the reference list by removing one or more reference entries for the citable information from the reference list. For example, if applications 104 revert to a previous state, then the reference builder program 102 can determine based on the state of the applications 104 which reference entries to remove from the reference list. In an embodiment, the reference builder program 102 tracks undo operations in the applications 104 to determine whether to remove a most recent reference entry from the reference list.

The nature of a removal of a reference entry from the reference list is dependent on how the reference list is stored. In an embodiment, the reference list is stored as a linked list data structure such that a most recent reference entry is added at the end of the linked list data structure. Adding the most recent reference entry to the linked list data structure involves setting a pointer from a previous last node or entry that points to the most recent reference entry. The most recent reference entry then becomes the last node of the linked list. In removing the most recent reference entry from the linked list data structure, the pointer pointing to the most recent reference entry is set to NULL. In a linked list data structure, removal involves resetting pointers. In an embodiment, the reference list is stored as a multi-dimensional array data structure and removal of a reference entry from the reference list involves removing entries from the multi-dimensional array data structure.

In an embodiment, reverting to a previous state of the applications 104 involves loading a configuration or data file from storage. Removal in this case can involve loading a reference list linked to the configuration or data file and selecting that reference list as the reference list to manage. That is, while a user is working with applications 104 and saves the state of the applications 104, then the reference builder 102 saves a reference list documenting the experimental procedure that created the state of the applications 104 being saved. The saved reference list is linked to the saved state of the applications 104 so that if the user reverts to a previous state of the applications 104, then the reference list linked to that previous state is loaded by the reference builder program 102.

At 214, if the type of citable information indicates a correction, then the reference builder program 102 modifies the reference list by updating an existing reference entry for the citable information in the reference list. For example, the reference builder program 102 can receive citable information from the applications including software version(s) of the applications 104, software version(s) of added features or toolboxes of the applications 104 being used, user identification or community identification of custom-made added features of the applications 104 being used and then updates an existing reference entry using the citable information. In an embodiment, the DOI of a dataset may point to a new URL so bibliographic citation of an existing reference entry of the dataset is updated.

At 216, the reference builder program 102 updates storage of data associated with the citable information by storing raw data generated by the identified citable process or removing of raw data associated with the identified citable process. For example, applying an algorithm to a dataset can transform the dataset so the applications 104 can then export the transformed dataset to external storage, e.g., database 118. In addition to the reference entry created for the export, the reference builder program 102 can generate a new DOI for the exported dataset. Removal of raw data can be performed as well when a dataset is removed from storage. A created DOI for the dataset will no longer be valid, and as such the reference builder program 102 can release the DOI.

In an embodiment, the reference builder program 102 can create a suggested reference entry for each entry in the reference entry. For example, bibliographic citation is updated through an open review of a journal paper, so a user prefers citing a most recent version of the journal paper. The reference builder program 102 can, for each reference entry in the reference list, search one or more reference databases to determine a suggested reference entry. The search can be an internet search including internet search engines, e.g., Google Scholar, Science Direct, Microsoft Academic Search, Academia, Mendeley, PubMed, Research Gate, Iowa Registry for Congenital and Inherited Disorders (IRCID), etc. The search can be local database searches, e.g., EndNote, Zotero, RefWorks, etc. Parameters used for searching can include names of the code snippets or routines, algorithms, datasets, or any other parameter included in a reference entry as previously described.

The reference builder program 102 can also create a suggested reference list including suggested reference entries created according to some embodiments of the disclosure for each reference entry in the reference list. The suggested reference list can include latest highly cited articles related to employed routines, algorithms and datasets. In an embodiment, the reference builder program 102 sorts suggested reference entries by date and by number of citations, creating a list of top 10, top 20, top 50, etc., most cited papers relevant to employed routines published in the last 2, 5, or 10 years.

In an embodiment, instead of or in addition to generating a suggested reference list, the reference builder program 102 replaces a reference entry in the reference list with a suggested reference entry. In another embodiment, the reference builder program 102 appends a reference entry in the reference list with a suggested reference entry. The suggested reference entry can be created according to some embodiments of the disclosure. The suggested reference entry can be a reference entry generated based on an internet search for the most cited paper relating to a citable process identified by the reference builder program 102. The suggested reference entry can be a reference entry generated based on an internet search for the most recent paper relating to the citable process identified by the reference builder program 102. For example, the reference builder program 102 may generate/update the reference list based on a citable action, and the reference builder program 102 may search then, for each reference list item, for similar references/publications in external databases (e.g. GoogleScholar, etc), to provide an overview of the latest publications on the specific item, e.g., ranked by popularity. Such a similar reference may be appended as a sub-item to a reference list item, or it may replace the reference list item itself.

In an embodiment, the reference builder program 102 exports the reference list and/or the suggested reference list to one or more reference, text or graphic formats for aiding a user in document preparation. Each reference entry is tagged so that the user can later identify the reference as being generated and exported by the reference builder. In an embodiment tags may take the form of a <note> or <annotation> tag so that reference manager software such as BibTex and Endnote can permit a user to search via a unique keyword for references generated using the reference builder program 102. The tagging of reference entries allows inclusion of bibliographic citations and references generated to be incorporated in a reference database, e.g., database 118.

In an embodiment, the reference builder program 102 can be embedded in one of the applications 104. For example, the reference builder program 102 can be embedded in scientific computation software or can be a separate tool interacting with the scientific computation software to manage the reference list. In an embodiment, the reference builder program 102 can run on the computing device 116 and monitor applications running on the other computing devices 120 through the network interfaces 112. Thus, a networked environment where the reference builder program 102 running on a first computer can monitor applications on other computer(s) and generate a reference list accordingly.

In an embodiment, the reference list and/or the suggested reference list can be exported to one or more reference formats for document preparation. Examples of reference formats include BibTex, Endnote, Microsoft Word, etc. A list is used as an example, as the references and suggested references can be provided in other forms such as tables, sequences, etc.

In an embodiment, a user on the computing device 116 is working on an application App01 and opens a toolbox on App01 to apply a certain data manipulation. The user defines the toolbox configuration/settings through I/O devices 108. For example, the application App01 can provide a graphical user interface (GUI) for the user to define the toolbox configuration and settings. Afterwards, the user can click a “Done” button on the GUI which then applies the intended data manipulation. After a successful execution, App01 can provide to the reference builder program 102 a “toolbox used” flag which is set to TRUE. The reference builder program 102 can then include a snapshot of the toolbox specific citation information (e.g. bibliography, settings, toolbox version, etc.) in the reference list. The manipulated data can be stored in database 118 alongside metadata identifying the toolbox citation information that generated the manipulated data.

Embodiments of the disclosure allow automated building of a list of comprehensive references and citations for steps and routines performed during data handling. Embodiments of the disclosure automatically generate a list of actually used algorithms, datasets, software version and settings, at a high level of convenience providing a complete reference for documentation and reproducibility of the data handling. Embodiments of the disclosure automatically generate a list of highly cited papers related to a particular stage of data processing and analysis by providing a suggested reference list or a suggested reference entry.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A device for managing a reference list, the device comprising one or more processors, which alone or in combination are configured to facilitate performing:
running one or more applications;
selecting a reference list;
monitoring activities in the one or more applications to identify citable processes;
receiving citable information from the one or more applications based on the citable processes;
determining a type of citable information received; and
modifying the reference list based on the type of citable information received.

2. The device according to claim 1, wherein selecting the reference list includes:
retrieving the reference list from storage; or
creating a new reference list.

3. The device according to claim 1, wherein monitoring the activities in the one or more applications to identify citable processes comprises:
determining whether the one or more applications is running a citable algorithm or any other process;
determining whether the one or more applications is importing a citable dataset; and
determining whether the one or more applications performed an undo or a revert operation; and
determining whether the one or more applications performed a save operation.

4. The device according to claim 1, wherein receiving the citable information from the one or more applications based on the citable processes comprises:
receiving an algorithm signature from the one or more applications;
receiving a dataset identification from the one or more applications;
receiving a software version of the one or more applications;
receiving a software version of an added feature of the one or more applications;
receiving a user identification or a community identification of an added feature of the one or more applications; and
receiving settings information of the one or more applications.

5. The device according to claim 1, wherein the type of citable information received includes an addition, a removal, or a correction.

6. The device according to claim 5, wherein the type of citable information received is an addition and modifying the reference list comprises:
generating a reference entry for the citable information; and
adding the reference entry to the reference list.

7. The device according to claim 5, wherein the type of citable information received is a removal and modifying the reference list comprises:
removing one or more reference entries for the citable information from the reference list.

8. The device according to claim 5, wherein the type of citable information received is a correction and modifying the reference list comprises:
updating a reference entry for the citable information in the reference list.

9. The device according to claim 1, wherein the one or more processors are further configured to facilitate performing:
updating storage of data associated with the citable information by storing raw data generated by the identified citable process or removing of raw data associated with the identified citable process.

10. The device according to claim 1, wherein the one or more processors are further configured to facilitate performing:
searching, for each reference entry in the reference list, in one or more reference databases to determine a suggested reference entry; and
creating a suggested reference list comprising suggested reference entries for each reference entry in the reference list.

11. The device according to claim 10, wherein the one or more processors are further configured to facilitate performing:
tagging each reference entry in the reference list and/or the suggested reference list.

12. A device according to claim 1, wherein the one or more processors are further configured to facilitate performing:
exporting the reference list to one or more reference formats for document preparation.

13. A device according to claim 1, wherein the one or more processors are further configured to facilitate performing:
searching, for each reference entry in the reference list, in one or more reference databases to determine a suggested reference entry; and
replacing at least one reference entry in the reference list with the suggested reference entry, wherein the suggested reference entry includes a most cited paper and/or a most recent paper.

14. A device according to claim 1, wherein the one or more processors are further configured to facilitate performing:
searching, for each reference entry in the reference list, in one or more reference databases to determine a suggested reference entry; and
appending at least one reference entry in the reference list with the suggested reference entry, wherein the suggested reference entry includes a most cited paper and/or a most recent paper.

15. A method for managing a reference list performed by a computing device, the method comprising:
running one or more applications;
selecting a reference list;
monitoring activities in the one or more applications to identify citable processes;
receiving citable information from the one or more applications based on the citable processes;
determining a type of citable information received; and
modifying the reference list based on the type of citable information received.

16. The method according to claim 15, wherein selecting the reference list includes:
retrieving the reference list from storage; or
creating a new reference list.

17. The method according to claim 15, wherein monitoring the activities in the one or more applications to identify citable processes comprises:
determining whether the one or more applications is running a citable algorithm;
determining whether the one or more applications is importing a citable dataset;
determining whether the one or more applications performed an undo or a revert operation; and
determining whether the one or more applications performed a save operation.

18. The method according to claim 15, wherein receiving the citable information from the one or more applications based on the citable processes comprises:
receiving an algorithm signature from the one or more applications;
receiving a dataset identification from the one or more applications;
receiving a software version of the one or more applications;
receiving a software version of an added feature of the one or more applications;
receiving a user identification or a community identification of an added feature of the one or more applications; and
receiving settings information of the one or more applications.

19. The method according to claim 15, wherein the type of citable information received includes an addition, a removal, or a correction.

20. The method according to claim 19, wherein the type of citable information received is an addition and modifying the reference list comprises:
generating a reference entry for the citable information; and
adding the reference entry to the reference list.

21. The method according to claim 19, wherein the type of citable information received is a removal and modifying the reference list comprises:
removing one or more reference entries for the citable information from the reference list.
